(19) United States
(12) Patent Application Publication
(10) Pub. No.: US 2026/0350644 A1
(43) Pub. Date: Nov. 5, 2026

(54) SYSTEMS AND METHODS FOR FACILITATING SECURE TRANSACTIONS AND QUALITY CERTIFICATION IN SPECIALTY COFFEE TRADING

(71) Applicant: Paulo Peres, Randolph, NJ (US)

(72) Inventor: Paulo Peres, Randolph, NJ (US)

(21) Appl. No.: 19/447,872

(22) Filed: Jan. 13, 2026

Related U.S. Application Data
(63) Continuation-in-part of application No. 19/185,627, filed on Apr. 22, 2025.

(51) Int. Cl. G06Q 30/0201

(52) U.S. Cl. CPC G06Q 30/0206

(57) ABSTRACT

The disclosure relates to computer-implemented systems and methods for estimating a spread over a benchmark price for specialty coffee lots using standardized classification identifiers and evidence-weighted comparables. Lots are encoded under a universal taxonomy (KUPIC). A pricing subsystem applies eligibility rules to select candidate neighbor observations and computes composite similarity scores that combine weighted attribute matches, an exponential recency decay, and a liquidity factor derived from trade depth. Anchors are computed across hierarchical scopes. An inferred spread over a contemporaneous benchmark, such as a nearest ICE “C” futures price, is produced together with uncertainty bands computed from a weighted variance and an effective sample size. The system exposes auditable outputs, including ranked neighbors, filters applied, weights, anchors used, parameter versions, and confidence intervals, and may interface with marketplace functions to render indicative offers and inform automated or restricted execution based on estimation confidence.

### CROSS REFERENCE TO RELATED APPLICATIONS

This application is a continuation-in-part of U.S. application Ser. No. 19/185,627, filed on Apr. 22, 2025. The prior application is incorporated herein by reference in its entirety.

### FIELD

The present disclosure pertains to systems and methods for pricing specialty coffee lots, specifically employing standardized classification identifiers, anchor-based estimations, neighbor similarity metrics, liquidity-dependent shrinkage, and confidence intervals to enhance price transparency and accuracy in thinly traded markets.

### BACKGROUND

The current green coffee trade is characterized by a complex and often fragmented system involving multiple stakeholders, including farmers, exporters, importers, roasters, and quality assessors. Traditionally, the trade is negotiated bilaterally, not in a central marketplace, and relies on manual processes and semi-digital systems, which can lead to significant inefficiencies and delays. Price discovery is often opaque, with limited access to real-time market data, resulting in information asymmetry and potential unfairness in transactions.

Quality verification is another critical aspect of the green coffee trade, where subjective assessments are conducted by trained professionals using established protocols, such as those from the Specialty Coffee Association (SCA). However, the integration of these quality assessments with market pricing is difficult, leading to inconsistencies and challenges in ensuring product credibility. The trade is further complicated by counterparty risks, as transactions typically require upfront payments, exposing buyers to potential delivery and quality issues. All parties in the current transactions are vulnerable to financial risks.

Because of these and other shortcomings, there is a strong need for systems and methods that provide improved methodologies for facilitating these market transactions.

### SUMMARY

In one embodiment, the disclosure provides a method for delivering an online marketplace and bilateral spot trading platform for green specialty coffee. The method comprises receiving coffee listing data from authorized users, wherein each listing includes a set of coffee parameters and at least one quality grade issued by a third-party quality certification. A computing device then determines a coffee group identifier for each listing based at least in part on the received parameters and generates an individual coffee identifier using the determined group identifier and quality grade information. A coffee group spreads curve is computed for each identifier based on historical trading data and current market information derived from a contemporaneous C-coffee traded financial instrument. The computed spreads curve, which represents indicative spot prices as a spread over the C-coffee price, is displayed on an online marketplace interface along with the associated coffee listings to provide an indicative offer price to sellers and an opportunity for buyers to submit counter-offer pricing data. Matching pairs of buy and sell orders are identified based on price and quantity criteria, and matching transactions are automatically executed by generating and transmitting electronic trade notifications along with a bilateral electronic trading agreement. The marketplace display is then updated to reflect executed transactions with details such as transacted quantities, volume-weighted prices, and last executed prices, and transaction data—including the listing data, generated identifiers, computed spreads curves, and transaction details—is stored.

A computer-implemented method is provided for estimating a spread over a benchmark price for a specialty coffee lot. The method includes encoding lot attributes under a universal taxonomy identifier comprising a KUPIC group code, selecting from historical observations a set of anchor values and a set of candidate neighbor observations according to attribute rules, computing for each candidate neighbor a similarity weight that incorporates attribute matches, a recency decay, and a liquidity component, forming a weighted estimator of spread from the candidate neighbors, computing a shrinkage coefficient configured to blend the weighted estimator with a KUPIC group prior mean, producing an inferred spread as a shrinkage-weighted combination of the weighted estimator and the KUPIC group prior, and outputting the inferred spread together with confidence bands representing an uncertainty interval around the inferred spread.

A system is provided for estimating a spread over a benchmark price for a specialty coffee lot. The system comprises one or more processors and memory storing instructions that, when executed by the one or more processors, cause the system to receive a target record encoded under a universal taxonomy identifier comprising a KUPIC group code and associated attributes including at least origin, region, plant species, plant variety, processing method, certification, SCA quality grade, screen size, and crop year; retrieve a plurality of historical observations each comprising an observed spread over the benchmark and associated timestamps and liquidity indicators; apply attribute rules to select a set of candidate neighbor observations for the target record; compute, for each selected neighbor observation, a similarity score comprising weighted attribute matches, a recency decay factor, and a liquidity factor; normalize the similarity scores to produce neighbor weights that sum to one; compute an attribute-weighted anchor value and blend the attribute-weighted anchor with anchor values selected from a hierarchy including at least a global baseline anchor, an origin-level anchor, and a region-level anchor; compute a shrinkage coefficient as a function of aggregate liquidity and a governance-controlled anchor weight parameter; form an inferred spread as a shrinkage-weighted combination of a weighted neighbor estimator and a KUPIC group prior; compute uncertainty bands around the inferred spread using a weighted variance and an effective sample size derived from the neighbor weights; and output the inferred spread, the uncertainty bands, and an auditable record identifying the selected neighbors, applied rules, similarity scores, weights, anchor values, and parameter settings.

A computer-implemented method is also provided for estimating a spread over a benchmark price for a specialty coffee lot. The method comprises receiving, by one or more processors, a target lot record encoded with KUPIC attributes including at least origin, region, processing method, plant species or variety, certification, screen size, crop year, and quality grade; applying eligibility filters to exclude records that fail one or more attribute, data validity, recency, liquidity, or benchmark consistency requirements; selecting a hierarchy of anchors for the target lot comprising at least a global baseline anchor, an origin-level anchor, a region-level anchor, and an attribute-weighted anchor derived from neighbor observations; identifying a set of candidate neighbor observations that pass the hard eligibility filters and for each candidate computing a composite similarity score comprising weighted attribute matches together with a recency decay factor and a liquidity factor; ranking the candidate neighbors based on the composite similarity scores; normalizing the composite similarity scores to produce neighbor weights that sum to one; computing a weighted delta estimator of deviation between observed neighbor spreads and corresponding anchor values; forming an inferred spread for the target lot as a shrinkage-weighted combination of a neighbor-based estimator and a KUPIC group prior mean, the shrinkage being a function of aggregate liquidity and governance-controlled parameters; computing an uncertainty estimate comprising a weighted variance and an effective sample size derived from the normalized neighbor weights to define confidence interval bounds around the inferred spread; and outputting the inferred spread, the confidence interval bounds, and an auditable record enumerating the filters applied, anchor values used, ranked neighbors, similarity scores, recency and liquidity factors, normalized weights, and parameter settings.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1A is a flow chart diagram illustrating the process of facilitating secure transactions and quality certification in the trading of specialty coffee.

FIG. 1B is a flow chart diagram that continues from FIG. 1A.

FIG. 2A is a flow chart diagram illustrating the process of facilitating secure transactions and quality certification in the trading of specialty coffee.

FIG. 2B is a flow chart diagram that continues from FIG. 2A.

FIG. 3 is a schematic diagram of a transaction platform for use with the methods and systems disclosed herein.

FIG. 4 is a flowchart of exemplary similarity and pricing engines.

FIG. 5 is flowchart showing an exemplary pricing module for specialty coffee.

FIG. 6 is a graph showing exemplary inferred spread curves.

FIG. 7 is flowchart showing an exemplary pricing module for specialty coffee.

### DETAILED DESCRIPTION

### Explanation of Terms

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

As used in this disclosure and in the claims, the singular forms “a,” “an,” and “the” include the plural forms unless the context clearly dictates otherwise. Additionally, the term “includes” means “comprises.” Further, the terms “coupled” and “associated” do not exclude the presence of intermediate elements between the coupled or associated items absent specific contrary language.

As used herein, a “C-coffee traded financial instrument” refers to a standardized futures contract for commodity coffee, of the type typically traded on major commodity exchanges.

As used herein, the term “spot trading” refers to purchase and sale of a commodity, like coffee, that involves transactions where the buyer and seller agree on a price, and the physical delivery of the commodity occurs shortly thereafter. Although the delivery of coffee may occur within a few days of the transaction agreement, the term spot trading, as used herein, is not limited to any particular delivery window. The price agreed upon in a spot trade reflects the current market value, or “spot price,” of the commodity at the time of the transaction.

As used herein, the term “coffee group spreads” refers to price differentials or spreads calculated for a group of coffee products that share similar attributes, such as origin, processing type, and quality grade. These spreads can be computed, for example, based on historical trading data and current market information. In some examples, the coffee group spreads can represent indicative spot prices as a spread over a contemporaneous C-coffee traded financial instrument, providing a benchmark for pricing within the coffee group.

As used herein, the term “escrow” refers to a financial arrangement in which a third-party service provider holds and manages funds on behalf of the transacting parties involved in a transaction, such as the specialty coffee trades described herein.

As used herein, the term “specialty coffee” refers to coffee that is recognized for its distinctive attributes, resulting in a higher value within the marketplace. Specialty coffee is typically characterized by superior quality, unique flavor profiles, and specific production methods that differentiate it from commodity coffee.

As used herein, the term “dynamic double-action trading” refers to a trading mechanism where buyers and sellers place competitive blind bids and offers. In dynamic double-action trading, as used herein, pre-agreement bids and offers are maintained on a blind basis, meaning that the identities of the parties and the specifics of their bids or offers are not disclosed until a match is found.

As used herein, the term “indicative offer price” refers to a preliminary price suggested by the systems and methods disclosed herein for a coffee listing, based on a calculation that considers historical and current market conditions. This price serves as a benchmark for sellers, providing them with an initial valuation of their coffee product.

As used herein, “UPIC” (Universal Product Identification Code) or “KUPIC” (Kaffea-X Universal Product Identification Code) are used interchangeably to refer to a standardized, machine-readable identifier that encodes objective, price-determinative attributes of a specialty coffee lot to enable unambiguous classification, grouping, and comparability across listings and transactions. A KUPIC comprises fields representing at least country of origin, region or subregion, processing method, plant species and, in some cases, plant variety, certification status, SCA quality grade, screen size, and crop year, and may further include metadata necessary for benchmark consistency and data validity.

As used herein, “anchors” are hierarchical reference values computed from historical spreads within defined scopes and used to stabilize and contextualize an inferred spread estimate for a KUPIC-encoded lot. Anchor tiers may include, without limitation, a global baseline anchor derived from market-wide observations, an origin-level anchor derived from observations within a single country of origin, a region-level anchor derived from observations within a defined subregion or cluster, and an attribute-weighted anchor derived from a similarity-weighted aggregation of observed neighbor spreads. In certain embodiments, a liquidity-adjusted anchor blends the attribute-weighted anchor with a normalized liquidity index to reflect contemporaneous market depth. Anchors serve as priors or baselines against which deviations from comparable observations are measured and to which neighbor-based estimators may be shrunk when liquidity is low.

As used herein, “neighbors” are candidate comparable observations associated with other KUPIC-encoded lots that pass hard eligibility filters and are scored for similarity to a target lot across price-determinative attributes. Neighbor records can include an observed spread over the benchmark together with timestamps and liquidity indicators, and are evaluated by computing attribute-level similarity scores (e.g., origin, region, processing method, certification, SCA grade, screen size, plant species/variety and crop year), optionally modulated by a recency decay and a liquidity factor. Normalized contributions from neighbors produce weights that sum to one, and the resulting weighted aggregation forms a neighbor-based estimator of spread that is combined with anchors to produce an inferred spread and associated uncertainty bands. Neighbors are auditable entities identified in the pricing output together with the filters applied, similarity scores, decays, liquidity factors, and contribution weights.

As used herein, “filters” are predefined eligibility and data integrity constraints applied to candidate observations before any similarity scoring or weighting is performed. Filters operate as deterministic gatekeepers that either admit or exclude a record from consideration as a neighbor. Filters may include mandatory attribute requirements such as exact processing method match or minimum SCA quality grade thresholds; provenance constraints such as country of origin equality and permissible region proximity per a defined taxonomy distance; crop-year windows relative to the target lot; certification parity where specified certifications are required; screen size band conformity; plant species and, where applicable, permitted variety family membership; benchmark consistency requiring spreads computed against the same benchmark specification and time synchronization; recency cutoffs that exclude observations older than a configured maximum age; liquidity floors that require minimum trade counts, traded quantities, or market depth; warehouse and logistics integrity checks that validate storage location and disallow embargoed facilities; and data validity checks that reject records lacking numeric spreads, timestamps, or falling outside configured sanity ranges.

As used herein, “attributes” are objective, price-determinative descriptors encoded in a KUPIC for each specialty coffee lot and used both for classification into a KUPIC group and for computing similarity between lots. Attributes may include country of origin, region or subregion, processing method, plant species and, where applicable, plant variety, certification status, SCA quality grade, screen size, and crop year, and may further include logistics or warehouse identifiers, blend versus single-origin classification, and benchmark metadata necessary to ensure consistency of spread computation. Attributes serve as the basis for filters, for attribute-level similarity scoring, and for anchor and prior computations within the pricing subsystem.

As used herein, “shrinkage” is a governed blending technique that tempers an estimate derived from local comparable observations with one or more baseline reference values or priors. When evidence quality or quantity is high, shrinkage permits greater reliance on the neighbor-based estimator; when evidence is sparse, stale, or noisy, shrinkage increases reliance on anchors or priors to maintain stability and robustness. Shrinkage parameters and behaviors are configurable under governance, and may depend on factors such as aggregate similarity, data recency, market depth, and data quality indicators.

As used herein, “liquidity” is a measure of market depth and transactional activity relevant to the specialty coffee group or neighborhood used for pricing. It reflects how readily trades occur and how much quantity is available across meaningful price levels. Liquidity can consider indicators such as the number of trades, traded volumes, and the presence of bid/offer interest within a price range. Higher liquidity signifies stronger, more reliable market evidence and supports greater weighting of empirical observations; lower liquidity indicates thinner markets and justifies greater reliance on anchors or priors, as well as wider uncertainty bands. Liquidity construction and thresholds are governance-controlled and auditable, with configurable inputs, time windows, and weighting schemes.

As used herein, “coffee group identifier” and “KUPIC group code” are synonymous and mean the standardized, machine-readable classifier that encodes the canonical, price-determinative attributes of a specialty coffee family, enabling unambiguous grouping, comparison, and computation of group-level anchors, priors, and spreads.

As used herein, “graphical user interface” (GUI) means a computer-implemented display and interaction layer that presents system outputs and controls in visual form to a user via one or more electronic displays. The GUI renders pricing information, charts, tables, and status indicators and accepts user input through devices such as a keyboard, mouse, touchscreen, or gesture controls. In certain embodiments, the GUI presents time-series charts of inferred spreads with uncertainty bands, displays observed spreads and anchor contributions, provides interactive tool-tips and drill-downs explaining neighbor selection and parameters, and exposes controls to select KUPIC groups, adjust confidence levels, and request API outputs. The GUI may further include navigation elements, filters, and dialogs to manage listings, view audit records, and initiate marketplace actions. It is well known in the art what a graphical user interface (GUI) is and how such interfaces are implemented to present information and receive user inputs.

As used herein, “governance and parameter control” means the configurable management framework that defines, stores, and enforces model and system settings-such as attribute weights, recency windows, liquidity index construction, shrinkage behavior, anchor weights, Top-K neighbor count, and confidence levels-together with versioning, access permissions, audit logging, and change tracking to ensure consistent, transparent, and reproducible operation across components.

Although there are alternatives for various components, dimensions, parameters, operating conditions, etc., set forth herein, that does not mean that those alternatives are necessarily equivalent and/or perform equally well. Nor does it mean that the alternatives are listed in a preferred order unless stated otherwise.

### Overview of the Disclosed Technology

The systems and methods described herein provide a novel marketplace and trading platform specifically designed for the bilateral spot trading of green specialty coffee. This platform aims to address the current shortcomings by providing a transparent and efficient trading environment. The platform facilitates direct and anonymous transactions between buyers and sellers, ensuring efficient price discovery and reducing credit risk for buyers through the use of an escrow account service. Additionally, the platform adopts one or more universal product classification system, allowing for precise comparisons across coffee varieties and accurate mapping to pricing curves. This system ensures fair and consistent valuation of all products offered on the platform, promoting transparency and fairness in the specialty coffee market.

### Embodiments of the Disclosed Technology

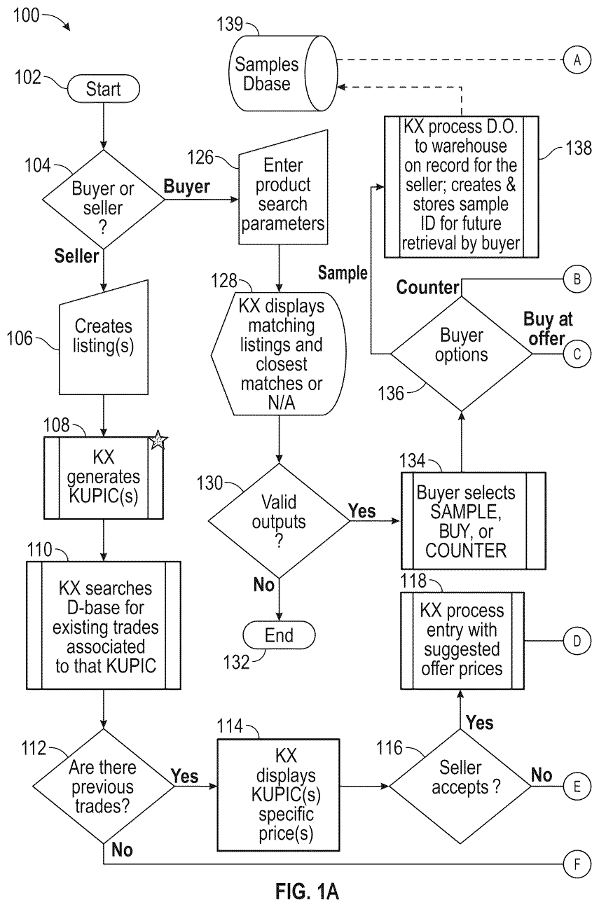

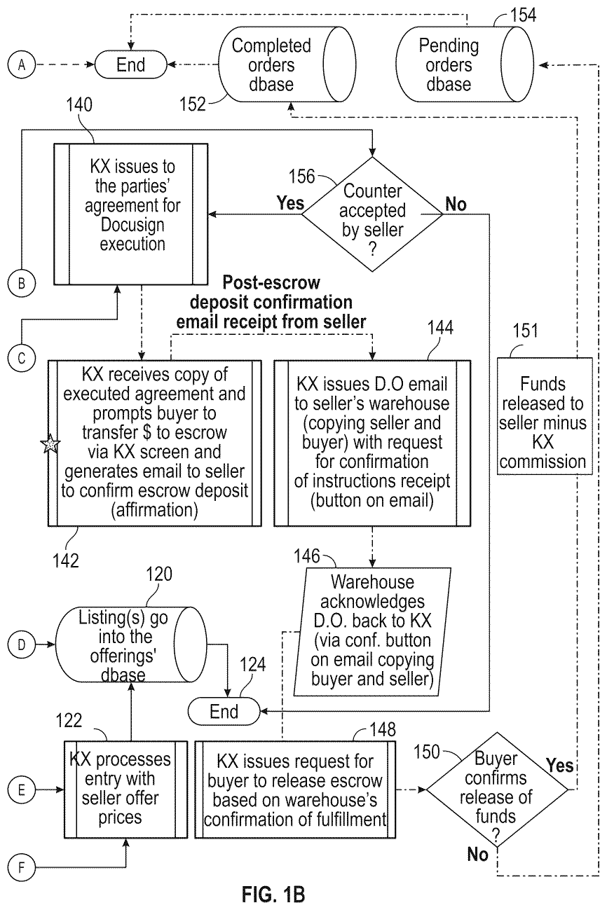

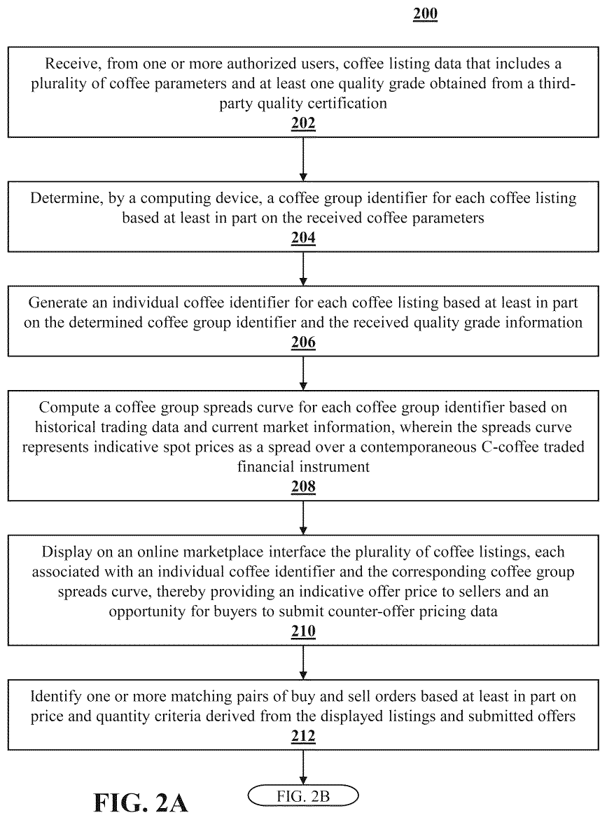

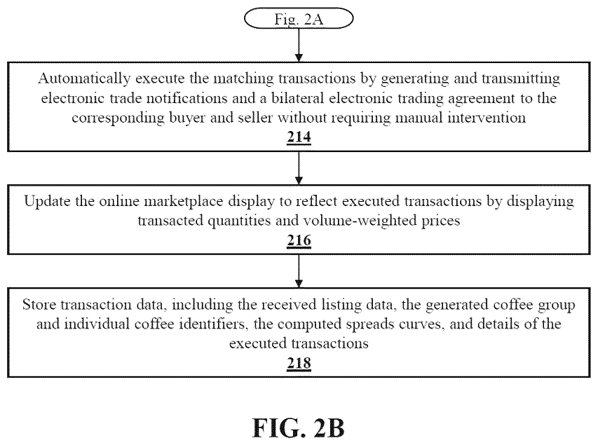

FIGS. 1A and 1B are flow chart diagrams illustrating the process of facilitating secure transactions and quality certification in the trading of specialty coffee.

The process 100 begins at step 102, which initiates the operation of the trading platform. This next step 104 serves as the entry point for users, prompting them to identify their role as either a buyer or a seller. The decision made at this stage determines the subsequent path within the trading process, directing users to either create listings or enter search parameters.

Sellers proceed to list their coffee products, while buyers are directed to search for available listings. For sellers, at step 106 (“Creates listing(s)”) the sellers are able to input details about their coffee products into the platform. In this manner, the system can gather important information such as coffee parameters, quality grades, and other relevant data that will be used to generate an identifier for each listing. This step provides the necessary data for the platform to generate a code, e.g., a Kaffea-X Universal Product Identification Code (KUPIC) at step 108, to facilitate subsequent trading activities. As used herein, the term Kaffea-X is occasionally used to refer to particular branding associated with the platform. It should be understood that the term platform and the term Kaffea-X platform, or similar combinations, can be interchangeably used.

The KUPIC is a unique alphanumeric identifier generated by the platform for each coffee listing. This code is based on the coffee's attributes, including, for example, its origin, processing type, bean size, and production year, as well as a quality grade, as provided by an accredited third-party quality assessment service. The KUPIC serves as a distinctive identifier that allows for precise comparisons across coffee varieties, facilitating trading. By standardizing product identification, KUPIC ensures transparency and consistency in the valuation of coffee products on the platform, promoting fair and efficient trading in the specialty coffee market.

At step 110 (“KX searches D-base for existing trades associated to that KUPIC”) the system queries the platform's database to identify any previous trades (e.g., step 112) associated with the generated KUPIC. This step provides sellers with historical pricing data and trade information, which can inform their pricing strategies and offer decisions. By accessing existing trade data, sellers can make informed decisions about their listings. If previous trades are found, the process continues to display specific prices (e.g., suggested pricing) related to those trades at step 114.

At step 116, the seller can accept the suggested pricing or reject the suggested pricing. If the buyer accepts the suggested pricing at step 118, the system proceeds to list the KUPIC with the suggested pricing, and at step 120 the listings go into the database for offerings.

If the seller rejects the suggested pricing, the seller can select and enter their own suggested pricing at step 122, and the seller created pricing enters into the database for offerings (e.g., step 120). This completes the listing process (step 124).

In the case of buyers, at step 126, the buyers can enter product search parameters to input criteria for the coffee listings they wish to find. This allows the buyers to filter the available listings based on the buyer's preferences, such as origin, processing type, and quality grade. By entering search parameters, buyers can efficiently locate coffee products that match their requirements, streamlining the process of finding suitable listings on the platform.

At step 128, the system displays matching listings and/or the closest matches, if any. The matching listings inform the buyers of their options moving forward, and facilitates the selection process by displaying the relevant information about each listing.

At step 130, the process either ends (i.e., at step 132 if there are no valid outputs) or continues at steps 134 and 136 where the buyer can review the matching listings and decide to buy at the listed price or counteroffer.

In some embodiments, the buyer can optionally also request a sample. At step 138, the sample request can be processed, e.g. prepared and sent to a location, such as a warehouse on record for the seller, where a sample can be created & stored with a unique sample ID for future retrieval by buyer.

Preferably, anonymity between the sample requester and provider can be maintained. For example, when a buyer requests a sample of a coffee listing, the system generates a sample ID that is associated with the specific coffee product but does not reveal the identities of the buyer or seller. This sample ID is used to track the sample throughout the logistics process, ensuring that the sample can be prepared, stored, and retrieved without disclosing personal or business information of the involved parties.

The sample ID acts as a reference point for both the buyer and seller, allowing them to manage the sample request and delivery without direct interaction. The platform handles all communications and logistics using this identifier, thereby preserving the anonymity of the participants. The sample ID is linked to the coffee's attributes and quality grade, enabling the buyer to assess the sample's credibility and make informed purchasing decisions while maintaining privacy. This approach mitigates potential biases or influences that could arise from knowing the identities of the parties involved, promoting fairer and unbiased transactions. In some embodiments, available samples can be stored in a samples database at step 139. Thus, a potential buyer will know in advance whether a sample is available or not.

Returning again to step 136, the buyer can agree to purchase at the listed price or counteroffer. If the buyer agrees to the purchase at the listed price, the system issues agreement documents to the parties at step 140, such as by an online authentication and signing system like DocuSign®. In this manner, the system generates and transmits suitable electronic trade agreements to the corresponding buyer and seller for execution via DocuSign. This formalizes the transaction and ensures that both parties have a legally binding agreement.

The platform can be configured to accommodate the diverse legal and logistical requirements of international coffee trading by preparing different agreements based on the geographical location of the trading parties. This ensures compliance with regional standards and practices, facilitating smooth transactions across borders. For example, for transactions involving parties located in the United States or regions where the Green Coffee Association's standards are recognized, the platform may prepare agreements based on these terms. These contracts typically include specifications related to quality, delivery, and payment, adhering to the established norms of the U.S. coffee trade.

In another example, for transactions involving parties located in Europe or regions where the European Coffee Federation's standards are applicable, the platform may prepare agreements based on these terms. These contracts are tailored to meet the specific requirements of the European coffee market, including quality assurance, logistics, and financial arrangements.

In yet another example, for parties located outside of the US or Europe, or for parties that prefer another agreement to meet particular trading practices or legal requirements, the platform may prepare custom agreements that incorporate different standards and regulations.

By preparing agreements that align with the geographical location of the trading parties, the platform ensures that transactions are conducted in accordance with relevant legal frameworks and industry standards. This approach minimizes the risk of disputes and enhances the reliability and efficiency of international coffee trading, providing a seamless experience for buyers and sellers across different regions.

Upon execution, at step 142, the platform can provide copies to buyer and seller of the executed agreement, and prompt the buyer to transfer the appropriate funds to escrow. Upon escrow deposit, the platform generates email to seller to confirm escrow deposit (affirmation).

At step 144, the platform issues instructions (e.g., by email) to seller's warehouse (e.g., copying seller and buyer in the form of a delivery order (D.O)) with a request for confirmation of instructions receipt. This ensures that both parties are informed of the delivery instructions and confirms the warehouse's acknowledgment at step 146. Thus, upon receipt of the instructions, the warehouse is informed, acknowledges the delivery order, and confirms that the fulfillment of the order is being processed.

At step 148, the platform requests that the buyer release escrow based on buyer's confirmation of fulfillment. At step 150, the warehouse either confirms that the funds are released from escrow and the order is completed (step 152), or does not confirm the transfer and the order is held as a pending order (step 154). If the escrow funds are released, at step 151, the funds are released to the seller minus a commission charged by the platform.

Returning again to step 136, the buyer can counteroffer. If the buyer counteroffers, at step 156, the counteroffer can be accepted or rejected by the seller. If accepted, the process proceeds to step 140 (discussed above) for formalization of the agreement. If rejected, the process ends (step 124).

The component at step 122 handles the entry of seller offer prices into the platform. This component is responsible for processing the seller's pricing data and updating the marketplace display, accordingly, ensuring that buyers have access to accurate and transparent pricing information.

### Further Details of the Disclosed Technology

As described above, the Universal Product Identification Code (KUPIC) for coffee represents a significant innovation in the specialty coffee trading industry. This feature introduces a standardized code that encapsulates the unique attributes of each coffee product, including its origin, processing type, bean size, production year, and quality grade. By integrating these diverse parameters into a single identifier, KUPIC transforms the way coffee is classified and traded, offering a level of precision and transparency previously unattainable in the market. This improvement not only facilitates transparent pricing but also enhances traceability, allowing buyers and sellers to track the provenance and quality of coffee throughout the supply chain.

The implementation of KUPIC is particularly significant in promoting fairness and efficiency in the specialty coffee market. By ensuring that each coffee product is evaluated against a uniform set of attributes, KUPIC eliminates the biases and discrepancies that can arise from subjective assessments. This standardization fosters a more equitable trading environment, where coffee products are valued based on their intrinsic qualities rather than external influences.

Moreover, KUPIC's ability to map coffee products to pricing curves introduces a new dimension of market analysis, providing traders with insights into price trends and market dynamics. This feature empowers stakeholders to engage in more strategic trading practices, optimizing their pricing strategies and enhancing their competitive edge in the market.

The platform also leverages third-party certification quality assessment services to ensure the quality and authenticity of coffee products. These services are provided by accredited entities that specialize in evaluating coffee based on established standards and protocols, such as those from the Specialty Coffee Association (SCA).

The process begins with sellers submitting their coffee products to the third-party certification service for evaluation. These services conduct thorough assessments, examining various attributes of the coffee, including flavor, aroma, acidity, and body. The evaluation is performed using standardized protocols, ensuring that the assessment is objective and consistent across different coffee varieties. Upon completion, the service issues a quality grade certification that reflects the coffee's attributes and overall quality.

This certification becomes a permanent part of the coffee's listing on the platform, including by its incorporation into the KUPIC, providing buyers with verified quality information. This integration of third-party certification into the trading process enhances the credibility and reliability of the marketplace.

The benefits of utilizing third-party certification quality assessment services are manifold. For buyers, the certification acts as a guarantee of quality, reducing the risk of purchasing substandard or misrepresented coffee products. For sellers, third-party certification offers a recognized standard of quality that can differentiate their products in the market. Certified coffee listings are more likely to attract buyers who prioritize quality and traceability, enhancing the marketability of the seller's offerings. Additionally, the certification provides a consistent framework for evaluating coffee quality, eliminating biases and subjective assessments, and promoting transparency in the trading process.

The automated electronic trading platform for specialty coffee described herein presents a significant leap forward in the modernization of coffee trading practices. This includes a sophisticated digital marketplace designed to streamline the trading process, enhance transparency, and mitigate risks associated with traditional coffee transactions. By leveraging advanced technology, the platform offers a seamless and efficient trading environment that caters to the unique needs of the specialty coffee industry.

In the traditional coffee market, transactions are often hindered by lack of a centralized marketplace, manual processes, fragmented systems, and a lack of real-time data, leading to inefficiencies and delays. The automated electronic trading platform addresses these challenges by providing a centralized digital space where buyers and sellers can interact directly and anonymously. This innovation facilitates efficient price discovery, allowing participants to access real-time market data and make informed decisions based on current trends and pricing dynamics.

The platform also incorporates a dynamic double-action trading mechanism, where competitive blind bids and offers are placed by participants. Trades are executed at the intersection of the highest bid and lowest offer, enabling flexible price discovery and promoting market transparency. This mechanism allows sellers to accept lower suggested prices, fostering a more adaptable and responsive trading environment.

Additionally, the platform described provides for sophisticated methods for calculating and representing spot prices for coffee holdings of varying quality grades within a specific coffee group. By employing specific algorithms, such as cubic spline functions and regression curve fitting techniques, coffee group identifier spreads curves can be developed and presented to provide traders with a precise and dynamic tool for price discovery. Presenting indicative spot prices as a spread over a contemporaneous C-coffee traded financial instrument ensures that the pricing reflects the latest market conditions and trends.

### Exemplary Transaction Platform

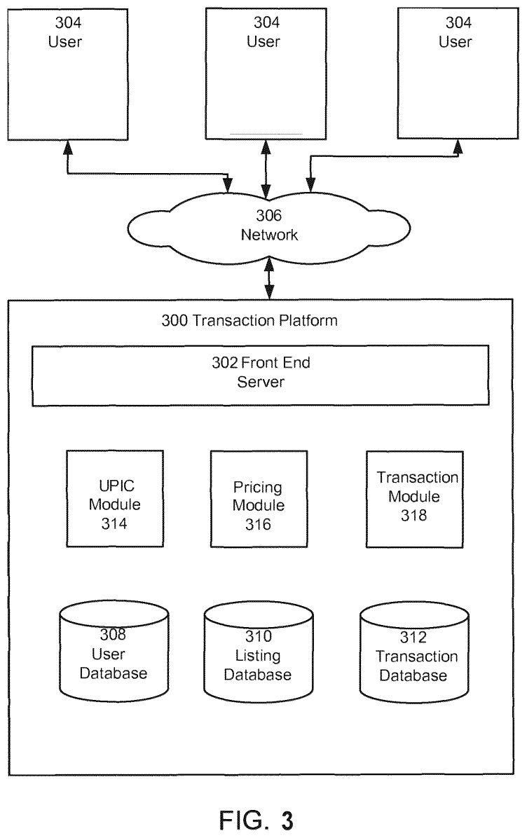

FIG. 3 shows a transaction platform 300 designed to facilitate secure bilateral spot trading of green specialty coffee, as described herein. The transaction platform 300 is connected to multiple users 304 (e.g., buyers and sellers) via a network 306. Within the transaction platform 300, there can be a front end server 302, a UPIC module 314, a pricing module 316, a transaction module 318, a user database 308, a listing database 310, and a transaction database 312.

The user 304 interacts with the transaction platform 300 through the network 306. This interaction allows the user 304 to access the platform's functionalities, including listing coffee products, submitting offers, and executing trades. The network 306 serves as the communication medium, ensuring seamless data exchange between the user 304 and the transaction platform 300.

The front end server 302 handles user interactions and requests. This server offers the interface that allows user 304 to access the platform's services. The front end server 302 processes incoming data from the network 306 and collaborates with other modules within the transaction platform 300 to provide the necessary functionalities.

The UPIC Module 314 generates identifiers for coffee listings, as described herein, based on their attributes, such as origin, processing type, and quality grade. This module ensures that each coffee product is distinctly identified, facilitating precise comparisons and efficient trading on the platform.

The pricing module 316 computes suggested pricing for different products with unique identifiers, such as pricing curves for coffee listings using historical trading data and current market information. This module provides indicative spot prices, enabling users 304 to make informed pricing decisions. The calculations performed by the module are important for establishing fair market values for coffee products.

The transaction module 318 manages the execution of trades between buyers and sellers. The module identifies matching pairs of buy and sell orders based on price and quantity criteria and automatically generates electronic trade notifications and agreements.

The user database 308 stores information related to the users 304, including their profiles and transaction history. The listing database 310 contains data on coffee listings, including their attributes and pricing information. This database supports the platform's capability to present accurate and current listings to users 304. The transaction database 312 records details of executed transactions, including timestamps and pricing data.

### Exemplary Pricing Models

The following exemplary pricing models relates to systems and methods for deterministic computation of Group-specific estimated spread over “C” levels and associated confidence intervals for commodities, and more particularly to specialty-coffee group pricing based on standardized classification identifiers (e.g., the unique alphanumeric identifier generated by the platform referred to herein as the KUPIC and/or KUPIC Group), reference anchor curves, and weighted similarity metrics when only sparse or noisy comparables exist.

Specialty green coffee trading exhibits extreme product heterogeneity and thin quotations at the lot level. Existing market data often lack stable identifiers analogous to CUSIPs in Financial Markets. This creates pricing opacity for “lonely” lots-coffees with few or no direct comparables in time or attributes-leading to adverse selection and illiquidity. Conventional regression or nearest-neighbor techniques either overfit to scant observations or ignore logistical constraints such as warehouse location or other price determining attributes which will be encoded in the KUPIC taxonomy employed here.

As described in more detail below, provided herein are computer-implemented systems and methods that: (i) encode lots under a universal product classifier (KUPIC™) to normalize attributes; (ii) identify Anchors (A0-A4) and Neighbors based on similarity metrics across attributes including Origin (Country), Region, Processing Method, Certification(s), Plant Variety, SCA Grade, and Screen Size; (iii) compute a liquidity-dependent similarity weight that down-weights stale or low-depth data; (iv) produce an inferred spread over a benchmark (e.g., ICE “C” contract) denoted \hat{μ}; together with a corresponding confidence interval (CI) and an auditable record of neighboring observations used in the estimation. The computation operates from a finite set of observed spreads over “C” (yi) and specific model parameters, and may optionally incorporate transactional data.

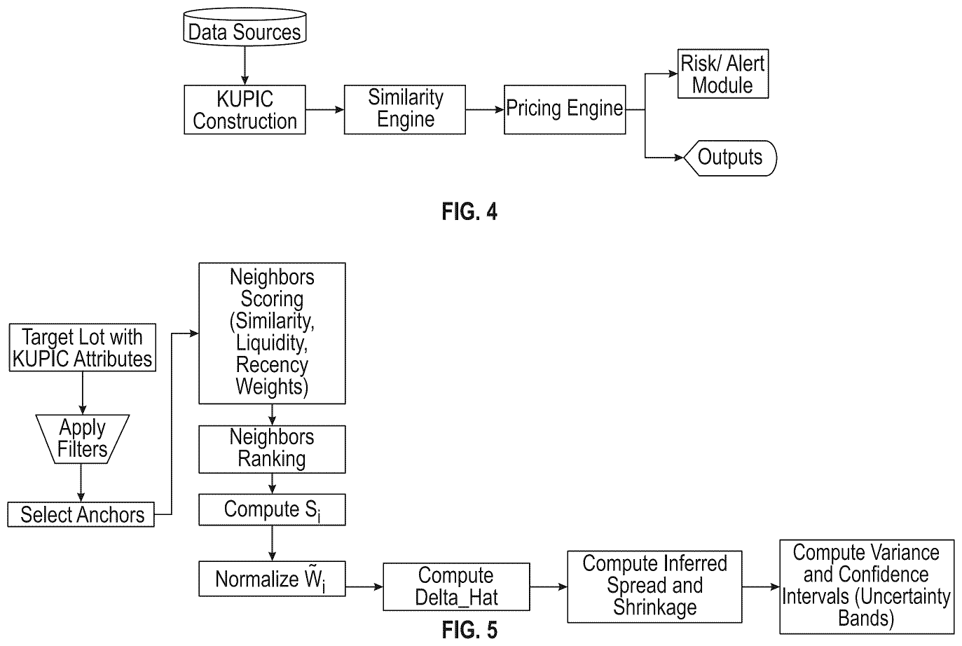

FIG. 4 shows a flowchart illustrating the operation of the similarity and pricing engines for determining the inferred spread and associated confidence intervals for a target lot of specialty coffee. The process integrates data sources, attribute-based similarity scoring, and pricing computations to produce outputs that include pricing estimates and risk alerts.

The process begins with data sources that provide the necessary inputs, such as historical trading data, observed spreads, and KUPIC attributes. These inputs are used to construct the KUPIC identifier for the target lot. The KUPIC Construction step encodes the lot's attributes, including origin, region, processing method, certification, and other relevant parameters, into a standardized identifier.

The Similarity Engine processes the target lot using the KUPIC attributes associated with the lot. Filters are applied to refine the dataset by removing irrelevant or non-comparable records. Anchors are then selected based on predefined criteria, such as origin, region, and quality grade, to establish a baseline for comparison.

The next step involves neighbor scoring, where potential comparable lots are evaluated based on similarity metrics. These metrics include attribute similarity, liquidity, and recency weights. Each neighbor is assigned a composite similarity score Si, which is calculated by combining weighted attribute matches with decay factors for recency and liquidity. The neighbors are then ranked based on their similarity scores, and the weights Wᵢ are normalized to ensure they sum to one.

The Pricing Engine uses the normalized weights to compute the weighted delta mean for the target lot. This value represents the deviation of the target lot's spread from the spreads of neighboring lots. The inferred spread and shrinkage are then calculated by combining the weighted delta mean with the anchor priors, using a shrinkage parameter to balance the influence of local observations and the anchor baseline.

The variance and confidence intervals (uncertainty bands) are computed to quantify the reliability of the inferred spread. The outputs of the Pricing Engine include the inferred spread, confidence intervals, and an auditable record of the neighboring observations used in the estimation. These outputs are passed to the Risk/Alert Module, which generates alerts and risk assessments based on the computed results. The resulting outputs are then made available for use in decision-making processes.

FIG. 5 shows a flowchart illustrating the process for specialty coffee pricing using a structured methodology that incorporates KUPIC attributes, anchor selection, neighbor scoring, and statistical computations to derive pricing spreads and confidence intervals.

The process begins with a target lot that is encoded with KUPIC attributes. These attributes include significant parameters such as origin, region, processing method, certification, SCA grade, screen size, and crop year. This encoding ensures that the lot is classified under a standardized taxonomy, enabling precise comparisons across coffee lots.

Next, filters are applied to the target lot. These filters enforce eligibility rules, such as minimum quality thresholds or matching processing methods, to ensure that only relevant data is considered in subsequent steps. The filtered data is then used to select anchors, which serve as reference points for pricing. Anchors are tiered comparables derived from historical data and are categorized into levels (e.g., global, origin, region) based on their relevance and specificity to the target lot.

Following anchor selection, the process moves to neighbor scoring. Here, potential comparable lots (neighbors) are evaluated based on similarity metrics, liquidity, and recency. Similarity is determined by matching attributes such as origin, processing method, and quality grade, while liquidity and recency weights account for the depth and timeliness of the data. Each neighbor is assigned a composite similarity score, which combines these factors.

The neighbors are then ranked based on their similarity scores, and their weights are normalized to ensure that the total weight sums to one. This normalization step ensures that the influence of each neighbor is proportionate to the relevance of the neighbor to the target lot.

Using the normalized weights, the process computes Δ_{Hat}, which represents the weighted deviation of the neighbors' observed spreads from their respective anchors. This value captures how similar lots have been trading relative to their anchor-based expectations. The inferred spread and shrinkage are then computed. The inferred spread is a combination of the anchor-based prior and the neighbor-based observations, adjusted by a shrinkage parameter. This parameter balances the influence of the anchor priors and the observed data, ensuring robust pricing even in cases of sparse or noisy data.

The process proceeds to calculate the variance and confidence intervals (uncertainty bands) for the inferred spread. The variance is derived from the weighted deviations of the neighbors, and the confidence intervals are computed using statistical methods to provide a measure of uncertainty around the inferred spread. These intervals offer a range within which the true spread is likely to lie, providing traders with a quantified level of confidence in the pricing estimate.

Thus, the flowchart of FIG. 5 illustrates a systematic and data-driven approach to pricing specialty coffee, addressing challenges such as market opacity, illiquidity, and heterogeneity in coffee lots.

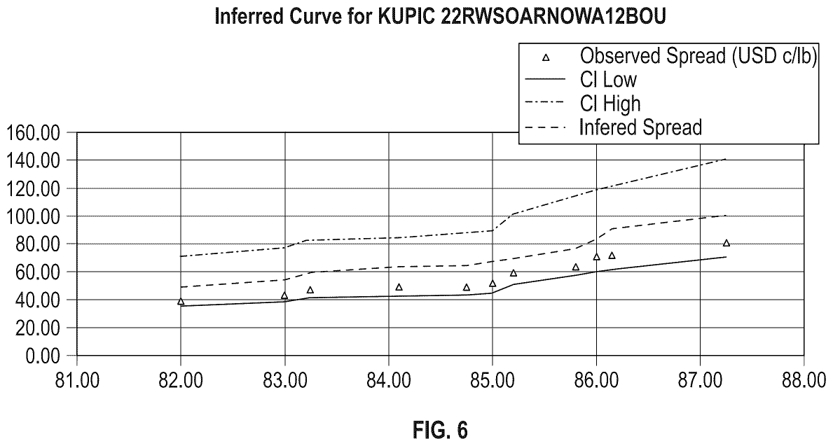

FIG. 6 shows an inferred spread curve for a specific coffee lot identified by its KUPIC code, illustrating the relationship between observed spreads, inferred spreads, and confidence intervals (CI) in the context of specialty coffee pricing. The graph provides a visual representation of the pricing dynamics for the coffee lot.

In certain embodiments, a graphical user interface is configured to present pricing outputs for a selected KUPIC group as a time-series chart that visually renders the inferred spread together with uncertainty bands and plotted observed spreads, similar to the graphical information illustrated in FIG. 6. The interface may display the inferred spread curve, upper and lower confidence interval bounds, and individual observations, and provide interactive tool-tips or overlays identifying contributing neighbors, applied parameters, and anchor references.

Observed Spread (USD c/lb) is represented by triangular markers. The observed spread data points indicate the actual recorded price differentials over the benchmark for the coffee lot. These data points serve as the basis for the computation of the inferred spread and confidence intervals.

The inferred spread is depicted as a solid line and represents the estimated price differential for the coffee lot, calculated using the disclosed methodology. This estimation incorporates factors such as anchor values, neighbor similarity weights, and liquidity adjustments to provide a robust and reliable spread value.

The graph includes upper and lower confidence interval bounds shown as dashed lines (CI High and CI Low, respectively). These intervals quantify the uncertainty associated with the inferred spread, providing a statistical range within which the true spread is likely to fall. The confidence intervals are derived from the weighted variance of the observed spreads and the model's shrinkage parameters.

The inputs to FIG. 4 and FIG. 5 are discussed in more detail below.

Each lot is encoded as KUPIC™=f(Origin, Region, Plant Species, Plant (Species) Variety, Processing Method, Certification, SCA Q-Grade, Screen Size, Crop-Year). Inputs include: Target Record, Achor Table, Input Universe, and Model Parameters.

The Target Record is a single row containing one or more of KUPIC ID and attributes (e.g., Origin, Region, Plant Species, Plant (Species) Variety, Processing Method, Certification, SCA Q-Grade, Screen Size, Crop-Year), Trade Date, Observed Spread (in USD Cents over “C”), and Liquidity Index. The Anchor Table is a mapping from KUPIC ID to Anchor, and the Input Universe comprises other rows possessing numeric Observed Spread (in USD Cents over “C”). The Model Parameters include similarity weights, decay half-life (or recency), liquidity floor (e), Liquidity Index, τ_anchor_weight, Confidence Intervals, Top-K neighbor count, observed trades and listings with timestamps, volumes, and spreads over benchmark.

The selection of anchors (FIG. 5) involves defining a plurality of graded anchor tiers (Aⱼ). In this example there are five (A₀-A₄). A₀ is the nearest high-quality comparable and A₄ the broad KUPIC Group prior. Tiers are determined by filters (e.g., SCA Q-Grade≥threshold, matching processing method) and recency/liquidity inputs.
A₀ (the Baseline Anchor) is a conservative, market-wide floor value applied when no meaningful comparable coffees exist. This can be initially set to 100 or a median of yᵢ at global level over the last 12 months.
A₁ (the Origin Anchor) is derived at the origin-Country level (e.g., Ethiopia, Colombia, etc.). A₁ can be a median of yᵢ at origin level over the last 12 months.
A₂ (the Region Anchor) refers to regional clusters (e.g., Sidamo Huila, etc.). A₂ can be a median of yᵢ at region level over the last 12 months.
A₃ (the Attributed Weighted Anchor) uses weighted similarity to nearby KUPICs (neighbors) with recorded trades. A₃ can be represented by

$${A}_{3} = \frac{{\sum }_{i = 0}^{n} {w}_{i} {y}_{i}}{{\sum }_{i = 0}^{n} {w}_{i}}$$

where wᵢ are weights for attribute matches (origin, region, processing method, Q-grade, screen size, certifications, variety) and yᵢᵢ are observed spreads for coffees of similar grade and processing across all origins, and ‘n’ is the number of coffees in the sample.
A₄ (the Liquidity Adjusted Factor Anchor) can be represented by

A₄=A₃(1−e^{-λL})

where L is the normalized liquidity index 0≤=L≤1, and can be derived as a weighted average of the number of trades within a given time period, based on the number of bags traded in the same period, and a measure of market depth, defined as the number of bags traded within a given price range. The respective weights for each of these inputs (#trades, #bags and depth), is user defined. λ is the shrinkage ratio controlling anchor trust in the local neighborhood (empirical market evidence) versus the anchor baseline (from prior KUPIC Group).

### Where:

$$λ = \frac{{\tilde{w}}_{i}}{( {τ}_{anchor \_ weight} ) + {\tilde{w}}_{i}}$$

where 0≤=λ≤1
τ_anchor_weight is a global variable, representing the importance the model places on the anchor baseline and it is set as a constant by the user based on the available data set.

Neighbor Similarity and Weights (FIG. 5) are provided as follows. For a candidate neighbor (i), attribute-level scores sₖᵢ are computed and combined into a composite similarity score for neighbor (i), that is, the weighted sum of attribute matches by recency and liquidity decays:

$${S}_{i} = {\sum }_{i = 0}^{n} {w}_{k} * {s}_{{k}_{i}} * {d}_{{recency}_{i} * {d}_{{liquidity}_{i}}}$$

where sₖᵢ is attribute-level similarity score for attribute k (e.g. Origin match, SCA Q-Grade exact match, graded distance), and 0≤sₖᵢ≤1; wₖ is a configurable specific weight for attribute k, such that higher-priority attributes (e.g., Origin weight=3, Region weight=2, etc.) receive greater relative importance in the final output.

Lastly, d_{recency} decays with age, and d_{liquidity} increases with market depth.

$${\tilde{w}}_{i} = \frac{{S}_{i}}{{\sum }_{j = 0}^{n} {S}_{j}}$$

wherein wᵢ is the normalized neighbor weight (summing to 1) and the denominator is the total composite similarity score across all candidate neighbors j.

The Weighted Delta Mean (Target-Neighbor Spread Deviation can be expressed as:

$$\hat{Δ} = {\sum }_{i = 0}^{n} {\tilde{w}}_{i} \text{?} {Δ}_{i} , {Δ}_{i} = {y}_{i} - {A}_{i}$$

$$\text{?} \text{indicates text missing or illegible when filed}$$

If \tilde{w}ᵢ=0=>\hat{Δ}=0
Recency (d_{recency})

$${d}_{{recency}_{i}} {e}^{⌈ - ( ln ( 2 ) \frac{DaysBetween ( {TradeDate}_{i}}{Decay \_ Half \_ Life \_ Days} ) ⌉}$$

E.g., if Decay_HalfLife_Days is set to 90, it means that when recorded trades are 90 days old they will contribute 50% as much as current ones; 180 days→25%; 270 days→12.5%, etc.

Inferred Spread and Shrinkage can be provided as:

\hat{μ}=(A₀+λ\hat{Δ})δ

where yᵢ are each neighbor's observed spreads over C (cents/lb.) and δ is an arbitrary downward bias scalar, 0≤δ≤1. The purpose of this scalar is due to the fact that it is easier to spur a thin market to level up than the other way around. This effectively defines inferred spread as a combination of both neighbor observations and anchor priors.
Shrinkage toward KUPIC Group prior μ₀:

μ_{λ}=λ\hat{μ}_neighbors+(1−λ)μ₀

Finally, Uncertainty Bands (FIG. 5) are confidence interval bounds around the inferred spread estimate that quantify estimation uncertainty given finite, weighted neighbor evidence. Computed (normalized) weighted variance is defined as:

$${\hat{σ}}^{2} = {\sum }_{i = 1}^{n} {{\tilde{w}}_{i} ( {y}_{i} - \hat{μ} )}^{2}$$

Confidence interval is thus determined by

$$C \text{?} = \frac{\text{?} \pm \text{?}}{\sqrt{{N}_{eff}}}$$

$$\text{?} \text{indicates text missing or illegible when filed}$$

where z_{α} is the statistical confidence quantile, i.e., for a 99% confidence interval, z_{α}=2.58 and N_{eff} is the effective sample size for weighted confidence interval estimation.

Referring to FIGS. 4 and 5, the system includes (a) software executed on a matching engine; (b) APIs emitting pricing, confidence intervals, and similarity explanations. As described above, methods for performing these actions include the following: Target Read (Retrieve the target record's KUPIC attributes, date, observed spread, and liquidity index); Anchor Lookup (Assign baseline anchor value A₀←Anchors [KUPIC ID]); Candidate Selection: Collect all other records with valid numericObserved_Spread_cents; Neighbor Scoring: For each candidate I compute Similarity, Recency, Liquidity components, Weight; Neighbor Ranking: Rank candidates by wk in descending order, retain the top k records as Similar_TopK; Weighted Delta Mean; and Shrinkage Coefficient (λ).

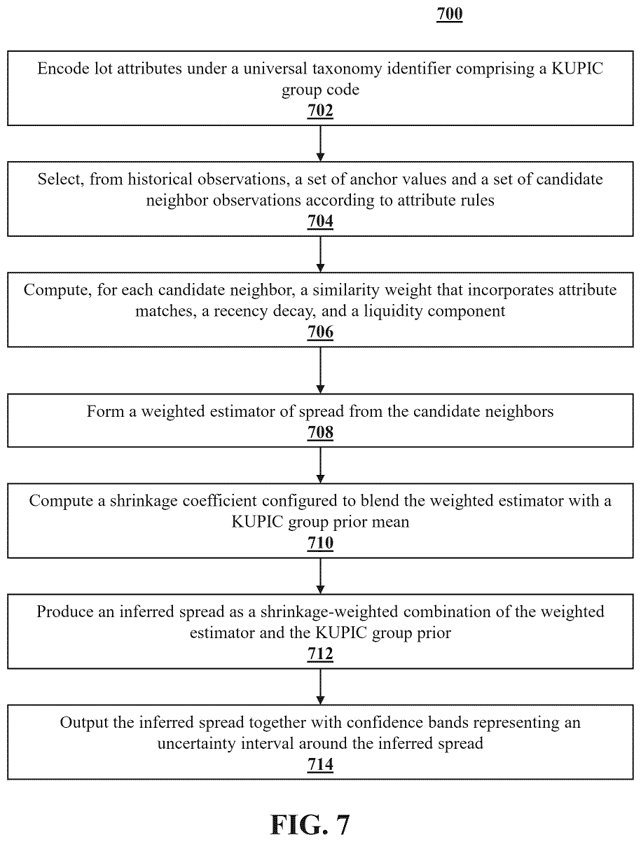

FIG. 7 shows a flowchart illustrating an exemplary process for estimating a spread over a benchmark for specialty coffee lots as described herein. As shown in FIG. 7, the process can use a combination of historical data, similarity metrics, and shrinkage techniques. The process involves multiple steps to encode, analyze, and compute an inferred spread with associated confidence intervals, ensuring accurate and transparent pricing for specialty coffee lots.

In step 702, the process begins by encoding the attributes of a coffee lot under a universal taxonomy identifier, specifically a KUPIC group code. This step standardizes the coffee lot's attributes, such as origin, processing method, and quality grade, into a structured format that facilitates comparison and analysis.

In step 704, a set of anchor values and candidate neighbor observations is selected from historical data. These selections are made based on attribute rules, which may include criteria such as origin, processing method, and recency of observations. The anchor values provide baseline reference points, while the candidate neighbors represent comparable coffee lots for further analysis.

In step 706, a similarity weight is computed for each candidate neighbor. This weight incorporates multiple factors, including attribute matches, a recency decay to prioritize recent data, and a liquidity component to account for market depth and trading activity. The similarity weight quantifies the relevance of each candidate neighbor to the target coffee lot.

In step 708, a weighted estimator of the spread is formed using the candidate neighbors. The estimator aggregates the observed spreads of the neighbors, weighted by their computed similarity scores, to provide an initial estimate of the target coffee lot's spread over the benchmark.

In step 710, a shrinkage coefficient is computed to blend the weighted estimator with a KUPIC group prior mean. The shrinkage coefficient determines the relative influence of the weighted estimator and the prior mean, balancing the use of local observations with broader group-level data.

In step 712, the inferred spread is produced as a shrinkage-weighted combination of the weighted estimator and the KUPIC group prior. This step ensures that the final spread estimate reflects both the specific characteristics of the target coffee lot and the general trends within the KUPIC group.

In step 714, the inferred spread is output along with confidence bands that represent an uncertainty interval around the spread. These confidence bands provide a measure of the reliability of the spread estimate, enabling users to assess the associated risk and variability.

This flowchart outlines a systematic approach to estimating spreads for specialty coffee lots, leveraging advanced computational techniques to enhance pricing transparency and accuracy in the specialty coffee market.

The following clauses provide additional examples of the disclosure provided herein.

### Additional Examples

The following clauses provide additional examples of the disclosure provided herein.

1: A method for providing an online marketplace and bilateral spot trading platform for green specialty coffee, may include: receiving, from one or more authorized users, coffee listing data that includes a plurality of coffee parameters and at least one quality grade obtained from a third-party quality certification; determining, by a computing device, a coffee group identifier for each coffee listing based at least in part on the received coffee parameters; generating an individual coffee identifier for each coffee listing based at least in part on the determined coffee group identifier and the received quality grade information; computing a coffee group spreads curve for each coffee group identifier based on historical trading data and current market information, where the spreads curve represents indicative spot prices as a spread over a contemporaneous C-coffee traded financial instrument; displaying on an online marketplace interface the plurality of coffee listings, each associated with an individual coffee identifier and the corresponding coffee group spreads curve, thereby providing an indicative offer price to sellers and an opportunity for buyers to submit counter-offer pricing data; identifying one or more matching pairs of buy and sell orders based at least in part on price and quantity criteria derived from the displayed listings and submitted offers; automatically executing the matching transactions by generating and transmitting electronic trade notifications and a bilateral electronic trading agreement to the corresponding buyer and seller without requiring manual intervention; updating the online marketplace display to reflect executed transactions by displaying transacted quantities and volume-weighted prices; and storing transaction data, including the received listing data, the generated coffee group and individual coffee identifiers, the computed spreads curves, and details of the executed transactions.

2: The method as paragraph 1 describes, where the plurality of coffee parameters includes origin, processing type, bean size, and production year.

3: The method as either of paragraphs 1 or 2 describe, where the at least one quality grade is an internationally recognized quality certification.

4: The method as any of paragraphs 1-3 describe, further may include receiving a coffee quality report generated by an accredited third-party quality assessment service provider, where activation of a coffee listing is contingent upon receipt of the coffee quality report.

5: The method as any of paragraphs 1-4 describe, where computing the coffee group spreads curve may include employing cubic spline functions and regression curve fitting techniques based on the historical trading data and the current price of a contemporaneous C-coffee traded financial instrument.

6: The method as any of paragraphs 1-5 describe, where displaying the online marketplace interface may include presenting the coffee listings on a graphical user interface that enables buyers to submit counter-offer pricing data and view real-time volume-weighted prices and last executed prices for a predetermined minimum lot.

7: The method as any of paragraphs 1-6 describe, further may include automatically executing the matching transactions through a dynamic double auction process, where pre-agreement bids and offers are listed anonymously.

8: The method as any of paragraphs 1-7 describe, where trade cancellations are permitted within a predetermined period following trade notification, subject to mutual agreement of the buyer and seller.

9: The method as any of paragraphs 1-8 describe, further may include generating and transmitting electronic trade notifications that include a legally binding spot trading agreement executed via an electronic signature process.

10: The method as any of paragraphs 1-9 describe, where updating the online marketplace display further may include reflecting transacted quantities, volume-weighted prices, and the last executed price per pound for a minimum lot of coffee.

11: The method as any of paragraphs 1-10 describe, where storing the transaction data may include recording timestamps for each receipt of coffee listing data, execution of transactions, and marketplace display update to facilitate audit and traceability.

12: The method as any of paragraphs 1-11 describe, where the escrow account service provider is a third-party financial institution that holds the buyer's deposit payment until confirmation of delivery and quality assessment of the coffee, at which point the funds are released to the seller, thereby mitigating credit and performance risk associated with the trade.

13: A computer-implemented method for facilitating secure bilateral spot trading of green specialty coffee, the method may include: receiving, via a computing device, coffee listing data from one or more authorized users, the coffee listing data including a set of coffee parameters may include origin, processing type, bean size, and production year, and a quality grade certification provided by an accredited third-party quality assessment service provider; generating, by the computing device, a distinct coffee group identifier for each coffee listing based at least in part on the received set of coffee parameters; generating, by the computing device, an individual coffee identifier for each coffee listing based at least in part on the generated coffee group identifier and the quality grade certification; computing, by the computing device, a pricing curve for each coffee group identifier based on a combination of historical spot trading data for green specialty coffee and a current market price derived from a contemporaneous C-coffee traded financial instrument, where the pricing curve represents indicative spot price spreads for varying quality grades within the coffee group; displaying, on an online marketplace interface accessible to the authorized users, the plurality of coffee listings, each associated with the distinct individual coffee identifier and the corresponding pricing curve, thereby providing an indicative offer price to sellers and enabling buyers to submit counter-offer pricing data; receiving, via the computing device, bid or counter-offer pricing data from a buyer for a selected coffee listing; identifying, by the computing device, at least one matching pair of buy and sell orders based at least in part on bid and offer prices and quantity criteria derived from the displayed listings and submitted pricing data; automatically executing, by the computing device, the matching pair of buy and sell orders to form a bilateral electronic trading agreement and generating electronic trade notifications for the corresponding buyer and seller without requiring manual intervention; and routing a deposit payment from the buyer to an escrow account service provider, where the escrow account service provider holds the payment until confirmation of delivery and quality assessment of the coffee is received, at which point the funds are released to the seller.

14: The computer-implemented method as paragraph 13 describes, where displaying the online marketplace interface further may include presenting real-time volume-weighted prices and the last executed price per pound for a predetermined minimum lot of coffee.

15: The computer-implemented method as either of paragraphs 13 or 14 describe, further may include identifying the matching pair of buy and sell orders by implementing a dynamic double auction process where pre-agreement bids and offers are maintained on a blind basis.

16: The computer-implemented method as any of paragraphs 13-15 describe, where receiving the bid or counter-offer pricing data may include accepting such pricing data via a graphical user interface that presents the coffee listings and corresponding pricing curves in real time.

17: The computer-implemented method as any of paragraphs 13-16 describe, where automatically executing the matching pair of buy and sell orders further may include generating and transmitting electronic trade notifications that include a legally binding spot trading agreement executed via an electronic signature process.

18: The computer-implemented method as any of paragraphs 13-17 describe, where routing the deposit payment further may include transmitting an electronic confirmation notification to the corresponding buyer and seller upon receipt of the deposit payment by the escrow account service provider.

19: The computer-implemented method as any of paragraphs 13-18 describe, where the escrow account service provider is a third-party financial institution that holds the buyer's deposit payment until confirmation of both physical delivery and an independent quality assessment of the coffee is received, and where the funds are released to the seller thereafter.

20: A system for facilitating secure bilateral spot trading of green specialty coffee via an online marketplace, may include: a network interface module configured to receive, from one or more authorized users, coffee listing data that includes a set of coffee parameters and an associated quality certification from a third-party quality assessment service provider; a coffee identifier module configured to determine a coffee group identifier for each coffee listing based at least in part on the received coffee parameters and to generate an individual coffee identifier for each listing based at least in part on the determined coffee group identifier and the associated quality certification; a pricing module configured to compute a coffee group spreads curve for each coffee group identifier based at least in part on historical trading data and current market information derived from a contemporaneous C-coffee traded financial instrument, where the computed spreads curve represents indicative spot prices as a spread over the C-coffee price; a display module operatively coupled to the network interface module and configured to present on an online marketplace interface the plurality of coffee listings, each associated with the generated individual coffee identifier and the corresponding coffee group spreads curve, thereby providing an indicative offer price to sellers and enabling buyers to submit counter-offer pricing data; a matching module configured to identify one or more matching pairs of buy and sell orders based at least in part on price and quantity criteria derived from the displayed listings and submitted counter-offer pricing data and to automatically transmit electronic trade notifications along with bilateral electronic trading agreements to the corresponding buyers and sellers without requiring manual intervention; an escrow module configured to route a deposit payment from a buyer to an escrow account service provider, where the escrow account service provider holds the deposit payment until confirmation of delivery and quality assessment of the coffee is received, thereby mitigating credit and performance risk associated with the trade; and a storage module configured to store transaction data including the received coffee listing data, the generated coffee group and individual coffee identifiers, the computed coffee group spreads curves, and details of executed transactions.

Example Clause A: A computer-implemented method for providing an online Marketplace and a bilateral spot Trading Platform for green specialty coffee, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in green coffee; receiving current prices of a C-coffee traded financial instrument; receiving from one or more authorized users of the Platform data that establish eligibility to be listed for sale of a holding of the coffee, where the data for each holding may include a weight certification, a certificate of origin, a third party certification of quality grade, and a set of parameters identifying a coffee family group through objective coffee attributes; receiving a plurality of listings of eligible coffee holdings, each listing may include a buy or sell order associated to one of a plurality of authorized users of the Platform (respectively, a buyer or seller), each order pertaining to a spot only transaction in green coffee; determining a coffee group identifier (a universal product identification code for a coffee family group) for each listed coffee holding, based at least in part on the parameters; determining an individual coffee identifier (a universal product identification code for a specific coffee bean) for each listed coffee holding, based at least in part on the parameters and the quality grade; causing to be displayed on a computer terminal connected to the Platform and accessible to the users the Marketplace, which may include the plurality of listings, each being a buy or sell order and each associated to a unique individual coffee identifier; computing for each coffee group identifier, a coffee group identifier spreads curve, representing spot prices for possibly hypothetical coffee holdings belonging to that coffee group of varying quality grades, based at least in part on the parameters and the quality grade; causing to be displayed on a computer terminal connected to the Platform and accessible to the users the coffee group identifier spreads curve, displayed as a spread over a contemporaneous (or nearly contemporaneous) price of the C-coffee traded financial instrument; providing to each seller an indicative price and an opportunity to revise its offer price at the time of listing, the indicative price being based on the corresponding coffee group identifier spreads curve; providing to each buyer an opportunity to propose a counter-offer price at the time of listing to a seller associated to a specific listing; identifying one or more pairs of matching orders from among the plurality of listings representing a buy or sell order, matching as to bid and offer price and unique identifier, and including pairs that may match in part as to quantity; executing the matching pair transactions automatically by means of an automated computing device, without requiring manual intervention by any user of the Platform, and sending to each of the corresponding pairs of seller and buyer an automatic electronic trade notification; upon completion of a transaction, updating the Marketplace display to display for each coffee the quantities and volume-weighted prices transacted, the last executed price per pound for a minimum lot, and to incorporate the extinguishing in whole or in part of orders subject to matching; storing the associated data, including: the received historical price data, with respective dates and times; the current prices of a C-coffee traded financial instrument, with respective dates and times; the transactions executed, each specified as to price, quantity, and individual coffee identifier, with respective dates and times; the periodic Marketplace displays, including bid and offer listings, with respective dates and times; for individual coffees, the daily last bid and offer, the last traded price, the last traded quantity; and the coffee group identifier spreads curves, with respective dates, times, and coffee group identifiers.

Example Clause B: The method of Example Clause A, where each one of the plurality of executed transaction pairs is completed as a transaction through the following steps, including the use of electronic notifications, such as emails: the Platform generates the automatic electronic trade notification, sent to each pair of buyer and seller; the Platform issues to each party of a pair of buyer and seller (the parties) a legally binding spot contract for execution (i.e., signing); upon receipt of a copy of the pair of executed agreements, the Platform automatically sends a notification to a settlement service provider of the details of the transaction, including the names of the parties; the Platform prompts the buyer to transfer the buyer's payment, in an amount specified by the Platform, to a settlement service provider's escrow account; upon the deposit of buyer's payment to the escrow account, the Platform automatically generates a notification to the seller to confirm the escrow deposit, i.e., a notification of trade affirmation, and the seller confirms to the Platform receipt of the notification; the Platform issues a delivery order notification to the seller's warehouse, the warehouse where the coffee subject to sale is stored, with copy notifications to the seller, the buyer, and the settlement service provider, and requests the warehouse to confirm, by an automated Platform reply mechanism, receipt of the delivery order instructions; upon receipt of the warehouse's acknowledgement of the delivery order and its confirmation of fulfillment of the order, the notifications being copied to the seller, the buyer, and the settlement service provider, the Platform issues a request to the buyer to release the deposited escrow account funds and the buyer confirms its authorization for release.

Example Clause C: The method of Example Clause A or Example Clause B, where the legally binding spot contract is a commonly accepted commercial contract (e.g., the Green Coffee Association Contract Terms and Conditions or the European Coffee Federation European Standard Contract).

Example Clause D: The method of any one of Example Clauses A-C, where the legally binding spot contract for execution is processed by a commonly accepted commercial method (e.g., DocuSign).

Example Clause E: The method of any one of Example Clauses A-D, where the payment to seller, the seller payment, is made net of a trading fee retained by the Platform, such as a percentage of the amount paid by the buyer.

Example Clause F: The method of any one of Example Clauses A-E, where the receiving the plurality of listings is supplemented by receiving instructions to cancel listings, each such instruction submitted by the user who posted the corresponding listing, and the updating the Marketplace display is supplemented by incorporating the extinguishing in whole or in part of orders subject to cancellation.

Example Clause G: The method of any one of Example Clauses A-F, where pre-agreement bids and offers are listed anonymously, the identifying one or more pairs of matching orders and the executing the matching pair transactions automatically may take the form of a dynamic double auction, and trade cancellations are restricted to a short window period after notification to the two parties through the automatic electronic trade notification.

Example Clause H: The method of any one of Example Clauses A-G, where the third party certification of quality grade is an internationally recognized certification, such as an SCA (Specialty Coffee Association) grade.

Example Clause I: The method of any one of Example Clauses A-H, where if the seller does not have a third party certification of quality grade, Platform will refer the seller to a list of recognized third party coffee assessment/grading services, to at least one of which the seller will send for analysis a sample of each coffee to be listed.

Example Clause J: The method of any one of Example Clauses A-I, where the set of parameters may include the coffee country of origin; the plant species; whether or not the coffee is organic; the size of the bean; the process, i.e., the manner in which the coffee is treated once it is harvested; the harvest year; and whether the coffee is of single origin or is a blend.

Example Clause K: The method of any one of Example Clauses A-J, where the country of origin is one of approximately 70 recognized coffee producing countries in the world, the plant species is typically one of 7 known plants (including Arabica, Robusta, Liberica, Hybrid, Excelsa, and Other), the variety is usually one of 57 different possible types, the size of the bean is expressed in 1/64th's of an inch, the process is typically one of 9 recognized processes for the treatment of specialty coffee beans post-harvest, the harvest year can span adjacent years (e.g., 2023/2024), and blend refers to a blend of coffees across different producers, whereas single origin refers to a single farm (or producer), including microlot coffees (coffees available only in small quantities).

Example Clause L: The method of any one of Example Clauses A-K, where the computing, for each coffee group identifier, a coffee group identifier spreads curve utilizes a mathematical algorithm employing cubic spline and regression curve fitting techniques.

Example Clause M: The method of any one of Example Clauses A-L, where the C-coffee traded financial instrument is a nearest C-coffee futures contract traded on I.C.E. (the InterContinental Exchange), and the coffee group identifier spreads curve is expressed as a spread over the C-coffee price in cents per pound.

Example Clause N: The method of any one of Example Clauses A-M, where the received historical price data include price data for coffee futures transactions.

Example Clause O: The method of any one of Example Clauses A-N, where the authorized user is one of a corporation, a limited liability company, a partnership, or a sole proprietor; the Marketplace and Trading Platform is made available to users on a 24-hour a day basis; the window period is 5 minutes; the minimum lot is 600 kg., representing 10 bags each of 60 kg.

Example Clause P: The method of any one of Example Clauses A-O, where use of the Platform to execute transactions does not guarantee performance of the bilateral contract between the buyer and the seller; does not guarantee the quality of the green coffee subject to the contract between the buyer and the seller; does not provide but only facilitates engagement of a settlement service, and settlement takes place off Platform; does not directly or indirectly obligate the Platform to be a party to or a participant in any trade or transaction entered or otherwise conducted through or on the Platform.

Example Clause Q: The method of any one of Example Clauses A-P, where, for the listed coffees taken as a whole, the coffee group identifiers, the individual coffee identifiers, and the coffee group identifier spreads curves provide a universal taxonomy for specialty coffee.

Example Clause R: The method of any one of Example Clauses A-Q, where the Platform generates advertising displays, and provides access to analytical reports on market statistics and market analyses, possibly in exchange for a subscription or other fee.

Example Clause S: A computer-implemented method for computing a specialty coffee market pressure indicator, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in green coffee; receiving one or more sets of current prices of spot quotes in green coffee, the quotes indicating bid or offer prices and associated quantities, and the prices being contemporaneous or nearly contemporaneous prices with each other; receiving current spot transaction prices in green coffee, with associated quantities, the transaction prices pertaining to execution times close to those of one set of the current prices of spot quotes (such as same day prices); receiving a value of an intermediation fee, expressed as a percentage of price; computing a market pressure indicator, based at least in part on the historical price data, the intermediation fee, the current quote prices, and the current transaction prices, where the frequency-of-occurrence distribution of the historical prices are transformed to a current distribution of prices through an Esscher transform (an exponentially tilted modification) depending on a value of the market pressure indicator as fixed coefficient of price in the exponent, and the value is selected to optimize fit to the quantity-weighted quote distribution, or an average of a set of quote distributions, with regard to its mean, variance, skewness, and kurtosis (and possibly higher moments); displaying the value of the market pressure indicator as a scalar number, either zero or a positive or negative number, on an online platform accessible to users of the platform by electronic means; storing the market pressure indicator.

Example Clause T: A computer-implemented method for providing an online Marketplace and bilateral spot Trading Platform for raw oysters, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in raw oysters, expressed in U.S. dollars per dozen; receiving from one or more authorized users of the Platform data that establish eligibility to be listed for sale of a holding of the oysters, where the data may include the number of oysters held, date of harvesting, an assurance of quality (e.g., hand selected and graded in the field and at the wet storage facility), whether or not the oysters are harvested in a sustainable way from traceable and verified clean open areas, the following four parameters: grow-out region (East coast, West coast, Gulf coast, Unspecified), species (e.g., Eastern, Pacific), size, and whether farmed or wild-caught, and specification of special attributes, which must include location of origin (e.g., a named bay, a named sound, a farm name, a farm owner), brand name, if any, and may include other attributes, such as taste profile using a specified scale, salinity, and grow-out method (e.g., bottom culture, off-bottom rack culture, off-bottom cage culture, off-bottom bag culture); receiving a plurality of listings of eligible oyster holdings, each listing may include a buy or sell order associated to one of a plurality of authorized users of the Platform (respectively, a buyer or seller), each order pertaining to a spot only transaction in raw oysters, and each sell or buy order subject to a respective minimum lot size at initial listing; and, separately, associated shipping costs charged by the seller to the buyer for delivery on a specified date to a specified address in a specified delivery region (one of four regions, South, Northeast, Pacific, Midwest) by a specified method of transportation (e.g., overnight delivery packed in an insulated box with cold packs); determining an oyster group identifier (a universal product identification code for an oyster family) for each listed oyster holding, based at least in part on the parameters; determining an individual oyster identifier (a universal product identification code for a specific oyster holding) for each listed oyster holding, based at least in part on the parameters and the special attributes; causing to be displayed on a computer terminal connected to the Platform and accessible to the users a Marketplace, which may include the plurality of listings, each being a buy or sell order and each associated to a unique individual oyster identifier; computing for each oyster group identifier, an oyster group identifier surface, representing spot prices for possibly hypothetical oyster holdings belonging to that oyster group of varying special attributes, based at least in part on the parameters, the special attributes, the delivery region (South, Northeast, Pacific, Midwest) and the associated shipping costs; causing to be displayed on a computer terminal connected to the Platform and accessible to the users the oyster group identifier curves, being cross-sections of the identifier surface varying with one special attribute at convenient fixed values of the other special attributes, displayed as a price per dozen oysters; providing to each seller an indicative price or price range and an opportunity to revise its offer price at the time of listing, the indicative price or price range being based on the corresponding oyster group identifier curves; providing to each buyer an opportunity to propose a counter-offer price at the time of listing to a seller associated to a specific listing; identifying one or more pairs of matching orders from among the plurality of listings representing a buy or sell order, matching as to bid and offer price and unique identifier, and including pairs that may match in part as to quantity; executing the matching pair transactions automatically by means of an automated computing device, without requiring manual intervention by any user of the Platform, and sending to each of the corresponding pairs of seller and buyer an automatic electronic trade notification; upon completion of a transaction, where in certain embodiments the buyer deposits payment in an escrow account, updating the Marketplace display to display for each oyster listing the quantities and volume-weighted prices transacted, the last executed price per dozen for a minimum lot, and to incorporate the extinguishing in whole or in part of orders subject to matching; storing the associated data, including: the received historical price data, with respective dates and times; the transactions executed, each specified as to price, quantity, and individual oyster identifier, with respective dates and times; the periodic Marketplace displays, including bid and offer listings for individual oyster holdings, with respective dates and times, the daily last bid and offer, the last traded price, the last traded quantity; and the oyster group identifier surface and curves, with respective dates, times, and oyster group identifiers.

Example Clause U: A computer-implemented method for providing an online Marketplace and bilateral spot Trading Platform for a soft commodity, where the soft commodity is boxed beef, or live cattle, or feeder cattle, or cotton, or cocoa, or sugar, or clams, or Bluefin tuna, or a soft commodity denominated in euro rather than US dollars, such as wheat, or barley, or maize, or any other soft commodity, may include: by a computing device, the device including one or more non-transitory computer-readable media storing computer-executable instructions which when executed by the computing device cause it to perform a method, the method may include: receiving historical price data, the historical price data indicating one or more historical prices for spot transactions in the soft commodity; receiving current prices for the soft commodity of a nearest futures contract traded on a commonly recognized futures trading exchange, if there exists such a contract; receiving from one or more authorized users of the Platform data that establish eligibility to be listed for sale of a holding of the soft commodity, where for each holding the data may include a warehouse name and its location, weight or quantity certification, a certificate of origin, a third party certification of quality grade if such a grade is commonly required in commercial transactions in the soft commodity, and a set of parameters identifying a soft commodity family group through objective attributes of the soft commodity; receiving a plurality of listings of eligible soft commodity holdings, each listing may include a buy or sell order associated to one of a plurality of authorized users of the Platform (respectively, a buyer or seller), each order pertaining to a spot only transaction in the soft commodity; determining a soft commodity group identifier (a universal product identification code for a soft commodity family group) for each listed soft commodity holding, based at least in part on the parameters; if a quality grade is received, determining an individual soft commodity identifier (a universal product identification code for a specific holding of the soft commodity) for each listed soft commodity holding, based at least in part on the parameters and the quality grade; causing to be displayed on a computer terminal connected to the Platform and accessible to the users a Marketplace, which may include the plurality of listings, each being a buy or sell order and each associated to a soft commodity group identifier, and, if a quality grade is received, a unique individual soft commodity identifier; if a quality grade is received, computing for each soft commodity group identifier, a soft commodity group identifier spreads curve, representing spot prices for possibly hypothetical soft commodity holdings belonging to that soft commodity group of varying quality grades, based at least in part on the parameters and the quality grade; if a quality grade is received and if a futures contract price is received, causing to be displayed on a computer terminal connected to the Platform and accessible to the users the soft commodity group identifier spreads curve, displayed as a spread over a contemporaneous (or nearly contemporaneous) price of the nearest futures contract; if only a quality grade is received but not a futures contract price, causing to be displayed on a computer terminal connected to the Platform and accessible to the users the soft commodity group identifier spreads curve, displayed as an absolute level of prices; identifying one or more pairs of matching orders from among the plurality of listings representing a buy or sell order, matching as to bid and offer price and identifier, and including pairs that may match in part as to quantity; executing the matching pair transactions automatically by means of an automated computing device, without requiring manual intervention by any user of the Platform, and sending to each of the corresponding pairs of seller and buyer an automatic electronic trade notification; upon completion of a transaction, where in certain embodiments the buyer deposits payment in an escrow account, updating the Marketplace display to display for each soft commodity the quantities and volume-weighted prices transacted, the last executed price for a minimum lot, and to incorporate the extinguishing in whole or in part of orders subject to matching; storing the associated data, including: the received historical price data, with respective dates and times; the current prices of a nearest futures contract, if applicable, with respective dates and times; the transactions executed, each specified as to price, quantity and applicable identifier, with respective dates and times; the periodic Marketplace displays, including bid and offer listings, with respective dates and times; for individual soft commodities, if applicable, otherwise for the soft commodity group, the daily last bid and offer, the last traded price, the last traded quantity; and, if applicable, the soft commodity group identifier spreads curves, with respective dates, times, and soft commodity group identifiers.

In view of the many possible embodiments to which the principles of the disclosed technology may be applied, it should be recognized that the illustrated embodiments are only preferred examples and should not be taken as limiting the scope of the disclosure. Rather, the scope of the disclosure is at least as broad as the following claims and equivalents of the recited features. I therefore claim all that comes within the scope and spirit of these claims.

1. A computer-implemented method for estimating a spread over a benchmark price for a specialty coffee lot, the method comprising:
encoding lot attributes under a universal taxonomy identifier comprising a KUPIC group code;
selecting, from historical observations, a set of anchor values and a set of candidate neighbor observations according to attribute rules;
computing, for each candidate neighbor, a similarity weight that incorporates attribute matches, a recency decay, and a liquidity component;
forming a weighted estimator of spread from the candidate neighbors;
computing a shrinkage coefficient configured to blend the weighted estimator with a KUPIC group prior mean;
producing an inferred spread as a shrinkage-weighted combination of the weighted estimator and the KUPIC group prior; and
outputting the inferred spread together with confidence bands representing an uncertainty interval around the inferred spread.

2. The method of claim 1, wherein the KUPIC group code is based on three or more attributes that are selected from Origin, Region, Plant Species, Plant Variety, Processing Method, Certification, SCA Q-Grade, Screen Size, and Crop Year.

3. The method of claim 1, wherein selecting the anchor values comprises selecting a baseline global anchor, an origin-level anchor, and a region-level anchor computed from medians or robust averages of historical spreads within respective scopes.

4. The method of claim 1, wherein computing the similarity weight for each candidate neighbor comprises:
determining attribute-level similarity scores across one or more attributes of the taxonomy;
applying a configurable attribute weight to each attribute-level similarity score;
applying a recency decay factor that decreases the contribution of older observations; and
applying a liquidity factor that increases the contribution of observations in markets exhibiting higher trade depth.

5. The method of claim 4, wherein the recency decay factor for a neighbor observation of age D days is computed as
$${e}^{- \frac{ln ( 2 ) D}{Decay \_ HalfLife \_ Days} .}$$

6. The method of claim 4, wherein the liquidity factor is derived from a normalized liquidity index L computed from a weighted combination of a trade count, traded quantity, and market depth within a price band.

7. The method of claim 1, wherein forming the weighted estimator of spread comprises normalizing the similarity weights so that they sum to one and computing a similarity-weighted average of observed neighbor spreads relative to the benchmark.

8. The method of claim 1, wherein the shrinkage coefficient is computed as a function of normalized aggregate similarity and a governance-controlled anchor weight parameter, and wherein the inferred spread approaches the weighted estimator when aggregate liquidity is high and approaches the KUPIC group prior when aggregate liquidity is low.

9. The method of claim 1, further comprising computing an uncertainty interval as confidence bands around the inferred spread using a weighted variance and an effective sample size derived from the normalized similarity weights.

10. The method of claim 1, further comprising exposing an application programming interface that returns, for a request comprising a KUPIC identifier and a confidence level, the inferred spread, confidence interval bounds, a ranked list of contributing neighbors, and the anchors used.

11. A system for estimating a spread over a benchmark price for a specialty coffee lot, comprising:
one or more processors;
memory storing instructions that, when executed by the one or more processors, cause the system to:
receive a target record encoded under a universal taxonomy identifier comprising a KUPIC group code and associated attributes including at least origin, region, plant species, plant variety, processing method, certification, SCA quality grade, screen size, and crop year;
retrieve a plurality of historical observations each comprising an observed spread over the benchmark and associated timestamps and liquidity indicators;
apply attribute rules to select a set of candidate neighbor observations for the target record;
compute, for each selected neighbor observation, a similarity score comprising weighted attribute matches, a recency decay factor, and a liquidity factor;
normalize the similarity scores to produce neighbor weights that sum to one;
compute an attribute-weighted anchor value and blend the attribute-weighted anchor with anchor values selected from a hierarchy including at least a global baseline anchor, an origin-level anchor, and a region-level anchor; compute a shrinkage coefficient as a function of aggregate liquidity and a governance-controlled anchor weight parameter;
form an inferred spread as a shrinkage-weighted combination of a weighted neighbor estimator and a KUPIC group prior;
compute uncertainty bands around the inferred spread using a weighted variance and an effective sample size derived from the neighbor weights; and
output the inferred spread, the uncertainty bands, and an auditable record identifying the selected neighbors, applied rules, similarity scores, weights, anchor values, and parameter settings.

12. The system of claim 11, wherein the attribute rules comprise at least one of requiring a strict match on processing method, enforcing a minimum SCA quality grade threshold, constraining region proximity according to a predefined taxonomy distance, and excluding observations lacking valid timestamps or spreads.

13. The system of claim 11, wherein the recency decay factor decreases the contribution of older observations according to a configurable half-life such that an observation of age D days is assigned a recency factor of
$${e}^{- \frac{ln ( 2 ) D}{Decay \_ HalfLife \_ Days} .}$$

14. The system of claim 11, wherein the liquidity factor is derived from a normalized liquidity index computed from a weighted combination of trade count, traded quantity, and market depth within a price band, and increases with market depth.

15. The system of claim 11, wherein the attribute-weighted anchor is computed as a normalized similarity-weighted average of observed neighbor spreads, and the liquidity-adjusted anchor is computed as a function of the attribute-weighted anchor and the normalized liquidity index.

16. The system of claim 11, wherein the shrinkage coefficient approaches one when aggregate liquidity is high and approaches zero when aggregate liquidity is low.

17. The system of claim 1, wherein computing the uncertainty bands comprises computing a weighted variance of the neighbors' observed spreads around the inferred spread and an effective sample size N_{eff} derived from the neighbor weights, and producing confidence interval bounds at a selected confidence level.

18. A computer-implemented method for estimating a spread over a benchmark price for a specialty coffee lot, the method comprising:
receiving, by one or more processors, a target lot record encoded with KUPIC attributes including at least origin, region, processing method, plant species or variety, certification, screen size, crop year, and quality grade;
applying eligibility filters to exclude records that fail one or more mandatory attribute, data validity, recency, liquidity, or benchmark consistency requirements;
selecting a hierarchy of anchors for the target lot comprising at least a global baseline anchor, an origin-level anchor, a region-level anchor, and an attribute-weighted anchor derived from neighbor observations;
identifying a set of candidate neighbor observations that pass the hard eligibility filters and for each candidate computing a composite similarity score comprising weighted attribute matches together with a recency decay factor and a liquidity factor;
ranking the candidate neighbors based on the composite similarity scores;
normalizing the composite similarity scores to produce neighbor weights that sum to one; computing a weighted delta estimator of deviation between observed neighbor spreads and corresponding anchor values;
forming an inferred spread for the target lot as a shrinkage-weighted combination of a neighbor-based estimator and a KUPIC group prior mean, the shrinkage being a function of aggregate liquidity and governance-controlled parameters;
computing an uncertainty estimate comprising a weighted variance and an effective sample size derived from the normalized neighbor weights to define confidence interval bounds around the inferred spread; and
outputting the inferred spread, the confidence interval bounds, and an auditable record enumerating the filters applied, anchor values used, ranked neighbors, similarity scores, recency and liquidity factors, normalized weights, and parameter settings.

19. The method of claim 18, further comprising causing a graphical user interface to render the inferred spread and the confidence interval bounds as a shaded band over a time-series chart for the corresponding KUPIC group, and enabling interactive tool-tips that display per-neighbor similarity explanations and parameter values upon cursor hover events.

20. The method of claim 18, wherein the eligibility filters comprise a benchmark consistency filter that excludes candidate neighbors whose spreads were computed against a different benchmark specification than the synchronized ICE “C” futures contract price used for the target lot.

21. The method of claim 18, further comprising persisting, in a transaction database, the inferred spread, confidence interval bounds, and parameter versions alongside executed marketplace transactions, and computing post-trade slippage metrics that compare executed prices to the inferred spread to update governance parameters for subsequent estimations.
